(19) United States
(12) Patent Application Publication
(10) Pub. No.: US 2022/0073336 A1
(43) Pub. Date: Mar. 10, 2022

(54) DEVICE FOR DELIVERING FROZEN OR CHILLED BEVERAGES

(71) Applicant: SOCIETE DES PRODUITS NESTLE S.A., Vevey (CH)

(72) Inventor: Gregory Savioz, Saxonne (CH)

(21) Appl. No.: 17/417,921

(22) PCT Filed: Dec. 20, 2019
(86) PCT No.: PCT/EP2019/086802

§ 371 Date: Jun. 24, 2021

(30) Foreign Application Priority Data
Dec. 26, 2018 (EP) 18215895.6

(51) Int. Cl. B67D 1/08; A23G 9/04; A23G 9/10; A23G 9/22; A47J 31/44; B67D 1/00

(52) U.S. Cl. CPC B67D 1/0895; A23G 9/045; A23G 9/103; B67D 1/0858; A47J 31/4492; B67D 1/0047; B67D 1/0053; A23G 9/224

(57) ABSTRACT

The invention relates to a device (10), a container (20), a system (100) comprising the device (10) and the container (20), and a method for delivering frozen or chilled beverages. The device (10) is provided for receiving a container (20) comprising a frozen product and for processing the frozen product of the container (20) for delivering a frozen or chilled beverage, wherein the container (20) comprises a first end (20a), a second end (20b) and a sidewall (20c) extending between the first end (20a) and the second end (20b). The device (10) comprises a slicing element (60) and a driving unit (50) configured to rotate the container (20) and thus the frozen product about a rotation axis for rotating the frozen product relative to the slicing element (60) in order to slice the frozen product. The device (10) further comprises a reading unit (41) configured to read a machine-readable identification element (22) of the container (20), wherein the reading unit (41) is positioned such that an identification element (22) provided on the sidewall (20c) of the container (20) is readable by the reading unit (41), when the container (20) is rotating about the rotation axis.

### 1. FIELD OF THE INVENTION

The present invention relates to a device for delivering frozen or chilled beverages, a container for such a device, a system comprising such a device and container, and a method for delivering frozen or chilled beverages.

### 2. TECHNICAL BACKGROUND

At present, the offer for beverage preparation devices delivering frozen beverages is relatively limited. The most known devices are granita devices embedding a cooling unit (compressor) and thus being very bulky and heavy, thus not suitable for home applications. Moreover, these devices are conceived for the preparation of large quantities of beverages and so need very long times to be ready for operation (typically, several hours). Similarly, water fountains and other cold beverage devices exist but do not guarantee real cold beverages and the products are often very limited, so they do not offer a real alternative to chilled ready-to-drink products.

Most frozen beverage devices known in the prior art, for example as described in document US 2011297272 A1, are very bulky and require the use of large cooling units; in fact, they are conceived for business applications (B2B). Some other devices known in the prior art disclose the dispensing of liquid product together with shaved ice (from water ice cubes) directly into a blending unit, being then blended, as per documents U.S. Pat. Nos. 5,960,701, 5,619,901 or US 2010151083 for example. However, these documents also disclose big and bulky devices not adapted to be easily used in home applications.

Devices for preparing the so called granita beverages are also known in the prior art as per documents US 2012055189 A1 or US 2004060307 A1. However, the devices described in these documents are also voluminous devices, requiring long operation times and not adapted for home applications.

In the prior art, there is also known a more compact system than the devices above. This system comprises a device, which prepares a frozen or chilled beverage by driving a frozen product in rotation and displacing the frozen product towards a slicing element such as a blade in order to slice the frozen product and subsequently use the sliced frozen product for the frozen or chilled final beverage.

The frozen product, typically provided in a packaging or container, is usually stored in a freezer before being inserted in the device. The frozen product can include different ingredients for different final beverages, in particular for different tastes. The frozen product can also be specifically processed by the device in order to receive a specific final beverage, e.g. with respect to a specific homogenization and/or solution and/or hydration of the frozen product in the final beverage. That is, there may be different recipes for preparing and processing the frozen product in order to receive the final beverage.

The information of the frozen product or the parameters for processing the frozen product may be provided by a machine-readable identification element. In the prior art, however, the mechanics and structure of the device considerably limit the way of reading such an identification element. In the prior art, the reading of the identification element requires, in particular, a considerable amount of space and, thus, negatively affects the compactness of the device.

Therefore, it is an object of the present invention to provide a device, a container for such a device, a system comprising such a device and container, and a method, which overcome the afore-mentioned drawbacks. In particular, it is an object of the present invention to read an identification element in a compact manner.

These and other objects, which become apparent upon reading the following description, are solved by the subject-matter of the independent claims. The dependent claims refer to preferred embodiments of the invention.

### 3. SUMMARY OF THE INVENTION

According to a first aspect of the invention, a device for receiving a container comprising a frozen product and for processing the frozen product of the container for delivering a frozen or chilled beverage, wherein the container comprises a first end, a second end and a sidewall extending between the first end and the second end, comprises: a slicing element, a driving unit configured to rotate the container and thus the frozen product about a rotation axis for rotating the frozen product relative to the slicing element in order to slice the frozen product, which is preferably displaced towards (or through) the second end of the container and thus towards the slicing element, and a reading unit configured to read a machine-readable identification element of the container. The reading unit is positioned such that an identification element provided on the sidewall of the container is readable by the reading unit, when the container is rotating about the rotation axis.

In other words, the driving unit is provided both for rotating the frozen product with respect to the slicing element in order to slice the frozen product and for bringing or passing the sidewall of the container, which comprises the identification element, in a position, in which the identification element is readable by the reading unit. Thus, any means for moving or rotating the reading unit in order to read the identification element can be omitted, since the typically slow rotating movement for slicing the frozen product is simultaneously used for appropriately reading the identification element by the reading unit. As such, a very compact device for reading an identification element (e.g. comprising processing parameters and/or information about the frozen product) provided on the container to be processed is obtained.

Preferably, the reading unit is configured to read the identification element in an identification element reading direction, and wherein, when viewed in a side view of the device, the identification element reading direction is substantially perpendicular to the sidewall and/or the rotation axis, and/or wherein the identification element reading direction intersects the rotation axis. The identification element reading direction may be an axis, in particular a symmetry axis, of a three-dimensional detection zone, e.g. in the form of a cone, in which the reading unit can read the identification element. Thus, the compactness of the device can be further improved.

The reading unit may be provided laterally with respect to the slicing element and/or the rotation axis. This is advantageous for the compactness of the device.

Preferably, the driving unit is configured to displace the frozen product along the rotation axis and towards (or through) the second end of the container and towards the slicing element. As such, the arrangement of the reading unit does not interfere with the displacing movement effected by the driving unit, while the reading unit can be still effectively arranged with respect to the driving unit.

The device may further comprise a holder for receiving the container, and wherein the driving unit is configured to rotate the holder about the rotation axis for rotating the container about the rotation axis. The holder particularly effects a secure reception of the container in the device. For a particularly good compactness of the device, the reading unit may be provided behind the holder, when viewed in a side view of the device.

The holder may comprise a receiving wall for receiving the container, wherein the receiving wall comprises an opening, through which the identification element provided on the sidewall is readable by the reading unit. Thus, the receiving wall effects a secure reception of the container, while still facilitating that the reading unit can reliably read the identification element.

The opening is preferably designed to extend in the receiving wall about the rotation axis such that for different orientations of the container about the rotation axis and with respect to the holder, the identification element is readable by the reading unit through the opening. Thus, the user of the device does not require to specifically place the container in the holder such that the identification element is readable by the reading unit through the opening, thereby improving the ease of use of the device.

The holder preferably comprises a handle, wherein the handle is connected to the holder such that the holder can rotate relative to the handle about the rotation axis. The handle is provided for handling the holder by a user of the device. Thus, the handle remains stationary while the holder rotates, thereby improving the ease of use and the compactness of the device.

The reading unit may be an optical reader, e.g. a barcode reader.

Preferably, the device further comprises an injection unit for providing a jet of liquid to the sliced product in order to dissolve and/or homogenize and/or hydrate the final beverage.

The device may comprise a heating unit adapted to be coupled with the container to at least partially detach the frozen product inside the container before it is sliced. For example, the heating unit may be designed with the holder for a particularly compact design.

The device may comprise a mixing chamber for receiving the sliced product, wherein, preferably, the injection unit is provided for injecting the jet of liquid into the mixing chamber. Preferably, the mixing chamber comprises a stirring element for stirring the sliced product in the mixing chamber.

The device preferably comprises a control unit being configured to control the driving unit, the injection unit, the heating unit, and/or the stirring element based on parameters read by the reading unit. Thus, the control unit control the respective parts of the device according to the parameters and/or information provided with the identification element as associated with the frozen product to be processed.

According to a second aspect of the invention, a container for a device as described above comprises a first end, a second end and a sidewall extending between the first end and the second end. The container is rotatable about a rotation axis for rotating a frozen product of the container relative to the slicing element in order to slice the frozen product, which is preferably displaced towards (or through) the second end of the container. The sidewall comprises a machine-readable identification element such that the identification element is readable by the reading unit, when the container is rotating about the rotation axis.

In other words, the identification element is not provided on parts of the container, which are affected or destroyed while processing the frozen product, in particular for displacing the frozen product towards or through the second end of the container. That is, the identification element is not provided on the first end (e.g. on the top of the container) and the second end (e.g. on the bottom of the container). And since the identification element is readable by the reading unit by rotating the container about the rotation axis, the reading unit is not required to move in order to read the identification element, i.e. the reading unit can remain stationary and guarantees the identification element is read in all cases. Thus, the container facilitates both that the identification element is not impaired, when being processed by the device, and that the reading unit can easily read the identification element.

Preferably, the first end of the container comprises a moveable lid for cooperating with the driving unit in order to displace the frozen product along the rotation axis and towards (or through) the second end of the container and towards the slicing element. The lid particularly functions as a protection both for preventing that the frozen product comes into direct contact with the device and for preventing that the device comes into direct contact with the slicing element. And since the identification element is not provided on the first end, but on the sidewall of the container, i.e. not provided on the lid or in the region of the lid, the pushing of the device on the lid does not negatively affect the identification element.

The second end of the container may comprise a further lid being designed for being removed from the container prior to the processing by the device. The further lid particularly functions as a protection for preventing that the frozen product degrades by way of the second end prior to the processing of the frozen product, thereby ensuring the quality of the frozen product. And since the identification element is not provided on the second end, but on the sidewall of the container, i.e. not provided on the further lid or in the region of the further lid, the removing of the further lid does not negatively affect the identification element.

The identification element may be a barcode, preferably a one- or two-dimensional barcode, in particular a QR-code. Alternatively or in addition, the identification element may be printed on the sidewall. Thus, the identification element can be provided on the sidewall in a very flat manner, thereby improving the compactness of the identification element on the sidewall of the container.

The identification element preferably includes information of the frozen product contained in the container and/or parameters for processing the frozen product of the container, preferably parameters relating to the control of one or more of the following (device parts):
a driving unit for rotating the container about the rotation axis and/or for displacing the frozen product towards the slicing element,
an injection unit for dissolving and/or homogenizing and/or hydrating the final beverage,
a heating unit for detaching the frozen product inside the container before it is sliced,
and/or a stirring element for stirring the sliced product in a mixing chamber.

Thus, the identification element may include or encode parameters required by the machine to properly process the product, in particular slicing speed effected by the driving unit, timing of the respective components of the device, water quantity, e.g. provided by the injection unit, water temperature, e.g. set by the injection unit, and/or blender velocity. These parameters or information of the frozen product may relate to different recipes of the final beverage (typically having a specific temperature and/or texture), which is produced from processing the frozen product.

According to a third aspect of the invention, a system for delivering frozen or chilled beverages comprises a device as described above, and a container as described above for being processed by the device. The reading unit of the device is positioned such that the identification element provided on the sidewall of the container is readable by the reading unit, when the driving unit of the device rotates the container about the rotation axis.

The above description and advantages of the device and the container apply analogously to the system. In particular, the system is particularly compact due to the specific design of the container and the specific position of the reading unit.

According to a fourth aspect of the invention, a method for reading a machine-readable identification element of a container comprising a frozen product, e.g. of the container as described above, and received in a device as described above for processing the frozen product of the container for delivering a frozen or chilled beverage, wherein the container comprises a first end, a second end and a sidewall extending between the first end and the second end, comprises the steps of: rotating the container and thus the frozen product by the driving unit about a rotation axis relative to the slicing element in order to slice the frozen product, which is preferably displaced towards (or through) the second end of the container, and reading a machine-readable identification element provided on the sidewall of the container by the reading unit, when the sidewall and thus the identification element rotate about the rotation axis.

The above description and advantages of the device, the container and the system apply analogously to the method.

### 4. DESCRIPTION OF PREFERRED EMBODIMENTS

In the following, the invention is described exemplarily with reference to the enclosed figures, in which

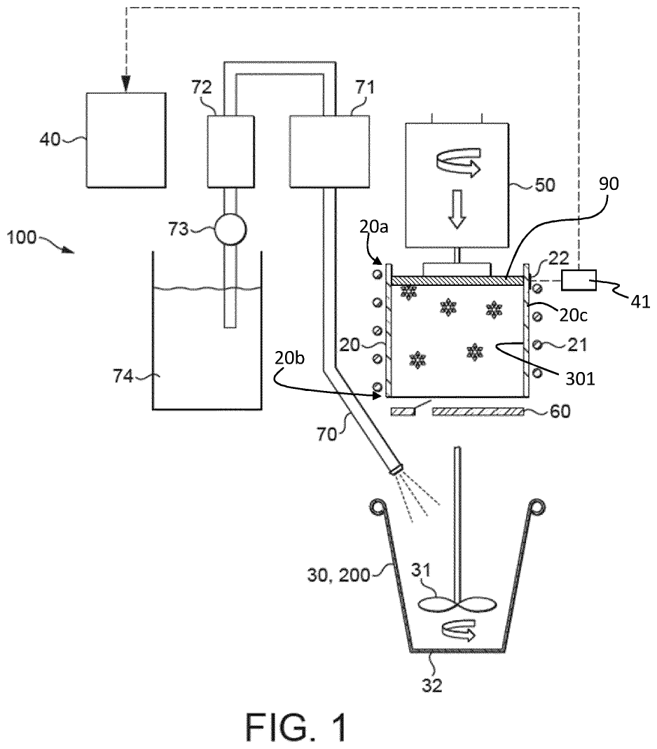

FIG. 1 shows a schematic view of a system and device for delivering frozen or chilled beverages according to one embodiment of the invention, where the frozen product in the container simultaneously rotates and displaces towards stationary slicing element;

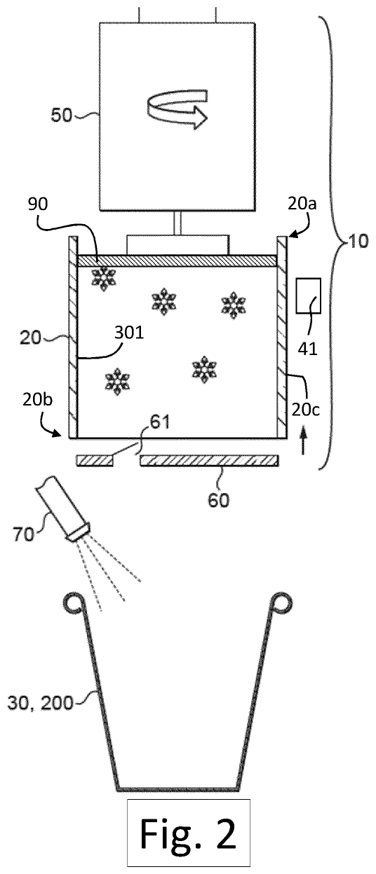

FIG. 2 shows a schematic view of a system and device for delivering frozen or chilled beverages according to another embodiment of the invention, where the frozen product in the container rotates while the slicing element displaces inside the container towards the product in it;

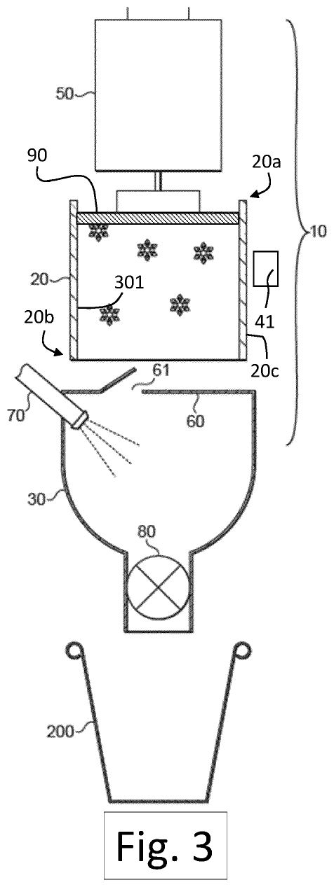

FIG. 3 shows a schematic view of a system and device for delivering frozen or chilled beverages according to the invention, further comprising a mixing chamber receiving the sliced product and an injection unit providing a jet of liquid into the mixing chamber;

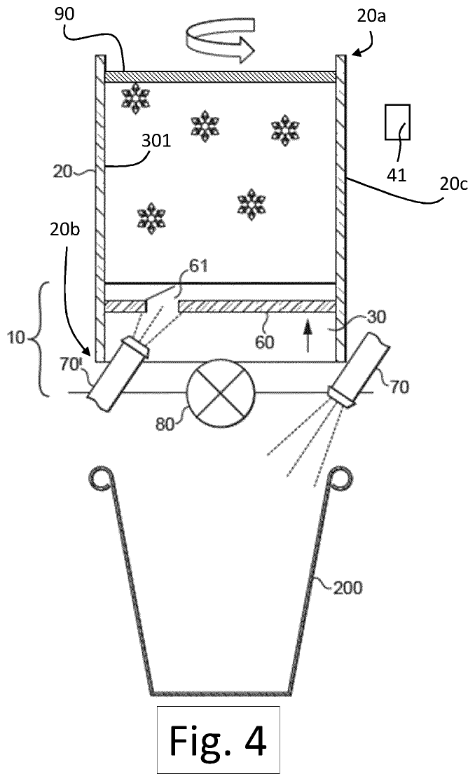

FIG. 4 shows a schematic view of a system and device for delivering frozen or chilled beverages according to the invention, wherein the container is provided with a mixing chamber;

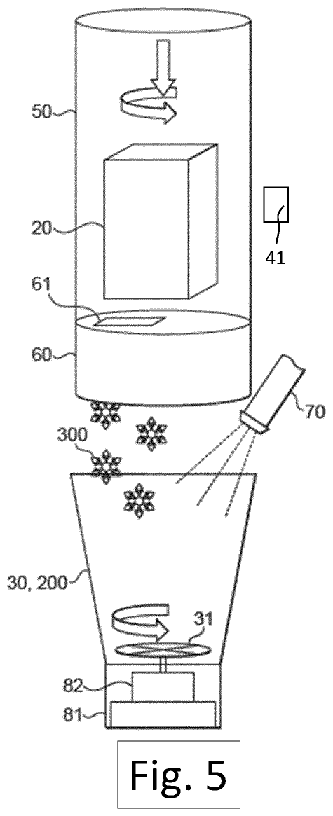

FIG. 5 shows a schematic view of a system and device for delivering frozen or chilled beverages according to the invention, further comprising a mixing chamber provided with a stirring element rotatable within said mixing chamber;

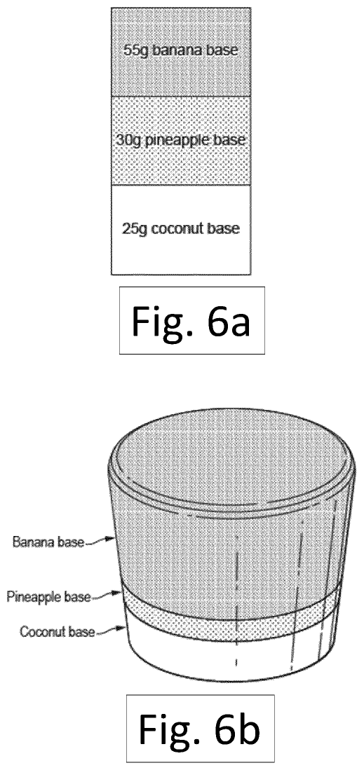

FIGS. 6a-b show schematically an example of a frozen product recipe to be prepared in a system for delivering frozen or chilled beverages according to the invention;

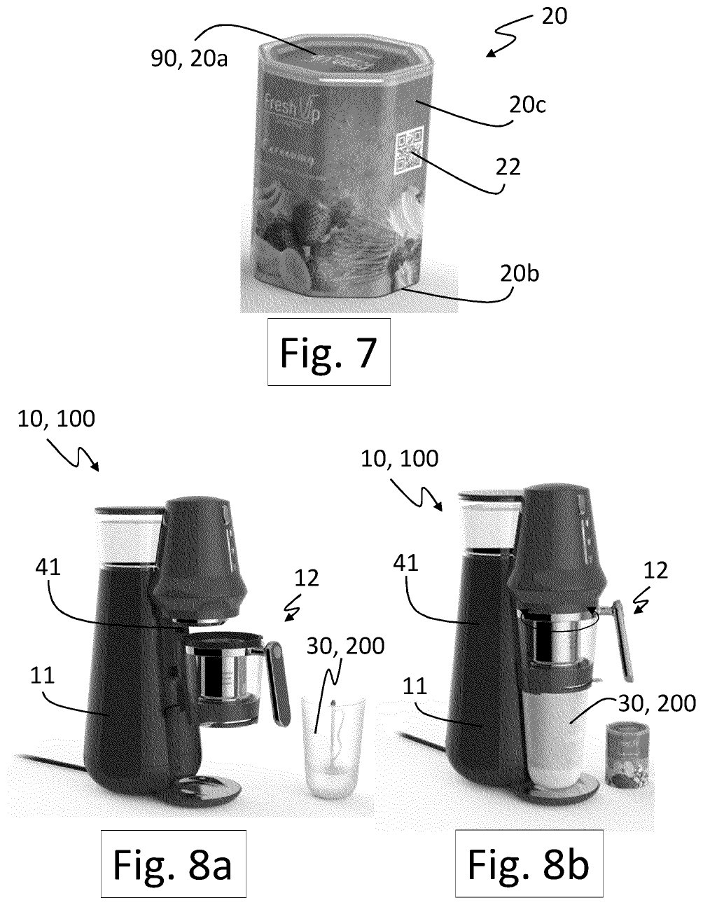

FIG. 7 shows a schematic perspective view of a container to be used in the system for delivering frozen or chilled beverages according to the invention;

FIGS. 8a-b show schematic views of a system and device for delivering frozen or chilled beverages according to a preferred embodiment of the invention in two different operating conditions;

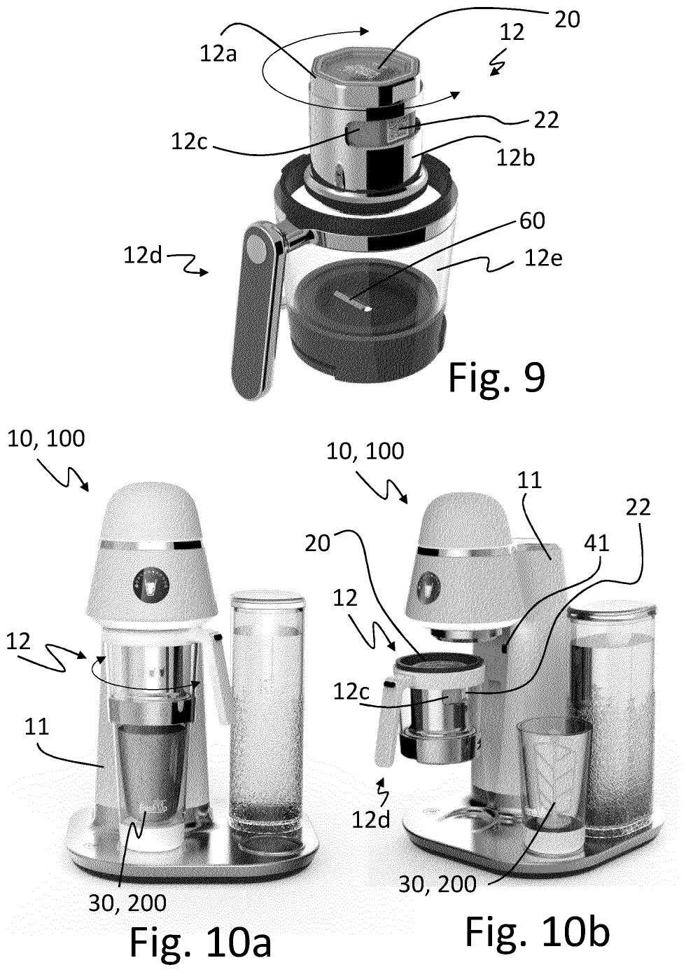

FIG. 9 shows schematically a perspective view of a holder with a mixing chamber to be used in the system or device for delivering frozen or chilled beverages according to the invention; and

FIGS. 10a-b show schematic views of a system and device for delivering frozen or chilled beverages according to a preferred embodiment of the invention in two different operating conditions.

The system 100 of the invention comprises a container or packaging 20 and a device 10, as represented for example in FIG. 2. The container 20 and the device 10, respectively, are aspects of the invention being independent from the system 100. The container 20 comprises a frozen product inside and the device 10 is configured for receiving the container 20 and for processing the product in the container 20 in order to deliver the final beverage. The container 20 comprises a first end 20a, e.g. the top of the container 20, a second end 20b, e.g. the bottom of the container 20, and a sidewall 20c extending between the first end 20a and the second end 20b, which surrounds the frozen product. The frozen product in the container 20 can be completely or partially frozen.

The frozen product inside the container 20 is typically coming from a natural and fresh product that is frozen before being used in the system 100 to prepare the frozen or chilled beverage from it. The idea is that, once the container 20 having inside the frozen product is attached to the device 10, the frozen product is sliced into flakes or small slices of product (still frozen) that will be sent into a cup or recipient 200, where a jet of liquid (typically water) will be added in order to prepare the final beverage. For producing the flakes or slices of frozen product, the system 100 will comprise a slicing element 60 relatively rotatable (moveable) about the rotation axis with respect to the frozen product in the container 20, so as to slice it. Different ways of moving the two (frozen product and slicing element) relative to each other can be envisaged, as it will be further explained in more detail in what follows.

The system 100 further comprises a driving unit 50 configured to provide the relative motion (rotation) about a rotation axis of the slicing element 60 and the frozen product in the container 20, as shown in FIG. 1. As further represented in this Figure, the system 100 further comprises an injection unit 70 providing a jet of liquid to the sliced product (the sliced product was sent to the recipient or cup 200) in order to dissolve and/or homogenise and/or hydrate the final beverage.

The frozen product can be driven directly by the driving unit 50 or indirectly by the driving unit 50 through the container 20. Indirectly driving (rotating) the frozen product by the driving unit 50 through the container 20 is preferred, since this reduces the direct contact between the frozen product and the device 10, driving unit 50, respectively. This means that, for example, in the case where you move the container 20 by rotation, the frozen product inside of it moves together with the container 20 (i.e. there is no sliding between container and the frozen product and they move solidarily). For example, the shape of the cross-section of the container inner wall 30 of the container 20 can facilitate such an indirect rotation of the product, e.g. by having such a shape that a relative rotation of the frozen product with respect to the container 20 and about the rotation axis is blocked. The driving unit 50 may be configured to displace or push the frozen product downwards by linear movement such that the frozen product is displaced towards or through the second end 20b and, thus, towards the slicing element 60, in particular along the rotation axis, so there is a vertical sliding of the frozen product with respect to the container inner wall 301, while both (container and frozen product) rotate at the same time.

As represented in FIG. 1, the injection unit 70 is configured to provide a jet of liquid to the frozen product sliced and they are thus connected to a water tank 74 through a water pump 72. Preferably, a flow meter 73 to control the flow of the jet injected is further provided and optionally also a heater 71, in order to offer the possibility of adding a hot jet of liquid instead. The jet of liquid provided by the injection unit 70 can be delivered into different shapes and/or configurations, such as a shower, having a conical shape, as a straight line, etc. Also, the injection unit 70 can be made moveable with respect to the product, in order to provide a faster speed of homogenization, hydration, mixing, or the like.

In the system 100, the type and characteristics of the beverage delivered depend on one or a plurality of the following parameters: the speed of the relative rotation (motion) of the slicing element 60 and of the frozen product in the container 20, the positioning of the frozen product within the system 100 and the temperature and/or quantity and/or flow rate of the jet of liquid provided to the frozen product, as well as the positioning of the interstice in the slicing element 60.

In the example shown in FIG. 1, the frozen product in the container 20 simultaneously rotates about the rotation axis and displaces towards the slicing element 60, and the slicing element 60 remains stationary. The slicing element 60 typically comprise a blade with an interstice 61 through where the frozen product will be sliced in small slices or flakes by the movement in rotation and displacement of the said block of frozen product with respect to the stationary blade and interstice 61. According to a possible embodiment of the invention, the height of this interstice 61 will be fixed but, according to another possible embodiment, this height can be regulated as desired (by means of a pivotable part, for example, rotating at one point).

Additionally, the slicing element 60 may move in rotation about the rotation axis. This relative movement of the product and the slicing element makes it possible to produce small slices or flakes of frozen product, similarly as in the previous case described.

FIG. 2 represents a further possible embodiment where the frozen product in the container 20 rotates while the slicing element 60 displaces inside the container 20 and towards the frozen product in it, in order to similarly produce slices or flakes of frozen product.

Still another embodiment is possible wherein the slicing element 60 simultaneously rotates and displaces inside the container 20 and with respect to the frozen product in it.

In order to make the frozen product inside the container 20 move with respect to the slicing element 60 (rotating about the rotation axis and displacing as in FIG. 1 or FIG. 5, or simply rotating as in FIG. 2 or 4), the container 20 can optionally be provided with a heating unit 21 (see FIG. 1) that facilitates detaching, at least partially, the frozen product from the inner wall 301 of the container 20, in order to initiate the movement of the product towards the slicing element 60 (movement thereafter may be continued by the driving unit 50). Depending on the product nature, it may be particularly advantageous to detach the frozen product from inside the container 20 by heating or pre-heating.

In another embodiment of the invention, the system 100 is further provided with a mixing chamber 30 to where the slices or flakes of frozen product are sent. There are several possibilities of incorporating this mixing chamber 30 in the overall system 100: the mixing chamber 30 can be the same as the recipient or cup 200 where the final beverage will be served (see for example FIG. 1 or FIG. 5) or it can be a separate part of the system (see FIG. 3) or it can be made as a separate part into the container 20 (see FIG. 4). In the example shown in FIG. 3, the flakes or slices of frozen product coming from the product inside the container 20 are sent into a mixing chamber 30 to where the injection unit 70 provides the jet of liquid in order to mix, homogenise, dissolve or hydrate the product before it is delivered into a recipient or cup 200. A valve 80 arranged at the exit of the mixing chamber 30 controls the flow of the beverage into the recipient or cup 200, as represented in FIG. 3.

Another example is shown in FIG. 4, where the mixing chamber 30 is arranged in the container 20: the frozen product inside the container 20 is made to rotate (after having been optionally detached by way of being heated from the inner walls of the said container 20, for example) and, while it is rotating, the slicing element 60 is configured to displace vertically upwards towards the rotating product. The volume of said mixing chamber 30 is variable depending on the relative movement of the slicing element 60 with respect to the product. This relative movement provides slices or flakes of frozen product into a mixing chamber 30, which is configured in the container 20 itself, as represented in this FIG. 4. A secondary injection unit 70′ can optionally be provided and configured to inject a jet of fluid (typically water) into this mixing chamber 30 to first mix, homogenize, hydrate and/or dissolve the flakes or slices of frozen product in that chamber 30. A valve 80 is arranged at the exit of the mentioned mixing chamber 30 in order to control the dispensing of the product in the said chamber into a recipient or cup 200. Further injection units 70 are configured to add a jet of liquid into the recipient 200 so as to prepare the final beverage. Both injection units 70 and 70′ can be provided or any one of the two, depending on different embodiments of the system of the present invention.

In the preferred embodiment of the system 100 shown in FIG. 5, the mixing chamber 30 further comprises a stirring element 31 rotatable within the inner volume of said mixing chamber 30. The frozen product inside the container 20 rotates and displaces vertically downwards towards slicing element 60, typically a blade, having a blade interstice 61, so that the frozen product is sliced (turned into small pieces, slices or flakes of frozen product 300). The sliced product 300 goes into a mixing chamber 300 (in this embodiment, the same as the recipient or cup 200) where an injecting unit 70 injects a jet of liquid to prepare the beverage. The mixing chamber 30 comprises a stirring element 31, typically configured as a whisk, rotatable within said chamber 30 by means of a motor 82 and controlled with the aid of a control unit 81. This control unit 81 can be rechargeable or inductive and/or can be made connectable to a power source.

In the preferred embodiment shown in FIG. 1, the mixing chamber 30 is also the recipient or cup 200 for the final beverage, to where the slices or flakes of frozen product are sent, and to where the jet of liquid from the injection unit 70 goes. In this embodiment, the device 10 further comprises a stirring element 31 rotatable by the driving unit 50 in the device 10. The stirring element 31 is preferably configured as a whisk. Optionally, the mixing chamber 30 can be provided with a further heating unit 32 to improve final mixing and homogenization of the beverage and/or to control the final beverage temperature. Also, the stirring element 31 can provide a certain level of foaming in the final beverage dispensed, when desired.

With the system 100 it is also possible to prepare beverages having different products departing from a layered initial frozen product, as for example represented in FIGS. 6a and 6b. Departing for example from a frozen product as shown in these Figures, comprising for example coconut, pineapple and banana, in exemplary quantities of 25 grams, 30 grams and 55 grams, for example, the final beverage prepared by the system will comprise these, as these components will be progressively sliced and sent into the final beverage. As different possibilities of slicing (shape and/or size of the flakes delivered) and/or quantity of liquid, typically water, provided to make the dissolution, the textures of the product provided into the beverage may be adapted. It is evident that other compositions and layers can be similarly used in the system of the invention. Compositions of products as solid products, liquid products, leaves (of basil, for example), purées, entire foods etc. could also be included in the frozen product in the container 20 so as to be delivered in the final beverage dispensed.

The system 100 or device 10 further comprises a reading (sensor) unit 41, which is configured to read a machine-readable identification element 22 of the container. An important aspect of the invention is the specific position of the reading unit 41 with respect to the container 20, which is rotated by the driving unit 50 about the rotation axis in order to slide the frozen product of the container 20. More specifically, the reading unit 41 is positioned such that the identification element 22 provided on the sidewall 20c of the container 20 is readable by the reading unit 41, when the container is rotating about the rotation axis.

In the embodiments shown in FIGS. 1 to 5 as well as 8a-b and 10a-b, the reading unit 41 is positioned such that an identification element reading direction of the reading unit 41, i.e. a direction, in which the reading unit 41 can read the identification element 22 (e.g. an axis or symmetry axis of a three-dimensional detection zone, which is formed, for example, as a cone), is substantially perpendicular to the rotation axis or side wall 20c, when viewed in a side view of the device 10 or system 100, and/or intersects the rotation axis. The reading unit 41 may be laterally provided with respect to the slicing element 60 and/or the rotation axis and/or the container 20. That is, the reading unit 41 may be provided behind the container 20, when viewed in a side view (i.e. when viewed perpendicular to the rotation axis) of the device 10.

With the positioning of the reading unit 41 as described above, the reading unit 41 can be provided stationary with respect to the device 10 or system 100, since the rotational movement for slicing the frozen product is simultaneously used for bringing the identification element 22 in a position, in which the reading unit 41 can read the identification element 22. Thus, and with reference to FIGS. 8a-b and 10a-b, the reading unit 41 can, for example, be integrally provided with a housing 11 of the device 10. The housing 11 may house other components of the device 10, in particular the driving unit 50. The housing 11 may house, additionally or alternatively, also other components of the device 10 such as the injection unit 70 and/or the water tank 74 and/or other electrical or electronic components for operating the device 10 (see FIGS. 8a-b).

With reference to FIGS. 8a-b and 10a-b, the reading unit 41 may be positioned such that in an operating mode, in which the container 20 is received by the device 10 in order to be processed (see FIGS. 8a and 10b), the identification element 22 of the container 20 is provided on the same height as the reading unit 41 or the identification element reading direction, wherein in a non-operating mode, in which the container 20 is detached from the device 10 in order to handle the container 20, e.g. for subsequently attaching the container 20 to the device 10 or for subsequently littering the container 20, the identification element 22 of the container 20 is not provided on the same height as the reading unit 41, e.g. below the reading unit 41 or the identification element reading direction.

As can be seen in FIGS. 8a-b, 9 and 10a-b, in particular in FIG. 9 in more detail, the device 10 may comprise a holder 12 for receiving the container 20. As such, the driving unit 50 is configured to rotate the holder 12 about the rotation axis for rotating the container 20 about the rotation axis. For example, the holder 12 may comprise a first holding part 12a, which can be coupled to a second holding part 12b, e.g. by a suitable fastening element such as a screw connection or a corresponding connection (snap fit, etc.). At least or only the first holding part 12a can transfer a rotational movement of the driving unit 50 to the container 20 and, thus, to the frozen product. The first holding part 12a may be correspondingly shaped to the sidewall 20c, i.e. the outer wall, of the container 20 for being coupled to the container 20 in order to transfer the rotation from the first holding part 12a to the container 20. That is, the holder 12, in particular the first holding part 12a, may connect to the container 20 by form fit. The holder 12, in particular the first holding part 12a, may in turn be connected to the driving unit 50 by form fit or any other suitable fastening element, e.g. by frictional forces, in order to transfer the rotational movement to the holder 12, the first holding part 12a, respectively.

The holder 12, preferably the second holding part 12b, may comprise a receiving wall for receiving the container 20, wherein the receiving wall comprises an opening 12c, through which the identification element 22 provided on the sidewall 20c of the container 20 is readable by the reading unit 41. Preferably, the opening 12c is designed to extend in the receiving wall about the rotation axis or the symmetry axis of the holder 12; in other words, the opening 12c may be designed as a (circular extending) slot. As such, the container 20 can be received by the holder 12 such that for different orientations of the container 20 about the rotation axis and with respect to the holder 12, the identification element 22 is readable by the reading unit 41 through the opening 12c.

The holder 12 may comprise a handle 12d, which is connected to the holder 12 such that the holder 12 can rotate relative to the handle 12d about the rotation axis. The handle 12d may be fixedly connected to a container 12e, which is adapted to receive the holder 12, in particular the second holding part 12e, such that the holder 12 can rotate with respect to the container 12e and, thus, with respect to the handle 12d. The container 12e may comprise the sliding element 60, e.g. provided on the bottom of the container 12e. The container 12e, in particular its bottom, may be configured to connect to the mixing chamber 30 or cup 200. The sliding element 60 may be fixedly connected to the container 12e in order to remain stationary. The container 12e may comprise a sidewall, which is at least partially or entirely transparent such that the reading unit 41 can read the identification element 22 through the transparent sidewall of the container 12e.

The reading unit 41 may be an optical reader, e.g. a barcode reader capable of reading one- and/or two-dimensional barcodes (QR-code, etc.). In other examples, the reading unit 41 may also be an RFID-reader.

The system 100 or device 10 of the invention will typically further comprise a control unit 40 functionally connected to the reading unit 41 in order to control at least the driving unit 50 based on parameters read by the reading unit 41, in particular parameters and/or information provided by the identification element 22. Additionally or alternatively, the control unit 40 may also control the injection unit 70, the heating unit 21, and/or the stirring element 31 based on the parameters read by the reading unit 41. The control unit 40 will typically comprise a human-machine interface (HMI).

With reference to FIG. 7, the container 20 will now be described in more detail. As described above, the container 20 comprises a first end 20a (e.g. the top of the container 20), a second end 20b (e.g. the bottom of the container 20) and a sidewall 20c extending between the first end 20a and the second end 20b. The container 20 is rotatable about the rotation axis for rotating the frozen product, preferably displaced towards or through the second end 20b of the container 20, relative to the slicing element 60 in order to slice the frozen product. The rotation axis is typically the above-mentioned rotation axis provided by the driving unit 50. Typically, the rotation axis is an axis or the symmetry axis of the container 50.

The sidewall 20c comprises the machine-readable identification element 22, preferably a barcode, e.g. a one- or two-dimensional barcode such as a QR-code. The identification element 22 may be printed on the sidewall 20c. The identification element 22 may be provided on a flat portion of the sidewall 20c, i.e. on a straight section of the cross-section of the sidewall 20c. Thus, the identification element 22 can be well recognized by the reading unit 41, since the identification element 22 is not bent or curved. In the example shown in FIG. 7, the sidewall 20c has the shape of an (regular) octagon. The sidewall or outer wall 20c is, however, not limited to a particular cross-section. For example, the cross-section of the sidewall 20c may be elliptically shaped and/or comprises at least one straight section and/or at least one round section and/or at least one, preferably at least two edges (e.g. rounded edge(s)). In particular, the cross-section may have the shape of a (regular) polygon. For example, the cross-section may have the shape of an ellipse, a rectangle or square, a rectangle or square having rounded edges, a (regular) triangle, a (regular) pentagon, a (regular) hexagon, a (regular) heptagon, an (regular) octagon, or a circle segment.

In the exemplary container 20 shown in FIG. 8, the cross-section is uniform along the rotation axis, i.e. preferably along the symmetry axis of the container 20. Alternatively, the cross-section may also be only partially uniform along the rotation axis. For example, the cross-section may be only or at least uniform along the rotation axis and in a region, where the identification element 22 is provided.

The identification element 22 may include any information relating to the frozen product or for processing the frozen product by the device 10 or system 100. That is, the identification element 22 may include information of the frozen product contained in the container 20 and/or parameters for processing the container 20, preferably parameters relating to the control of one or more of the following components of the device 10 or system 100: the driving unit 50, the injection unit 70, the heating unit 21 and/or the stirring element 31. In particular, the parameters for processing the container 20 may relate to the speed of the relative motion of the slicing element 60 and of the frozen product, positioning of the frozen product within the system, temperature and/or quantity and/or flow rate of the jet of liquid provided.

With the positioning of the identification element 22 on the sidewall 20c of the container 20, the identification element 22 is thus readable by the reading unit 41, when the container 20 is received by the above described device 10 and, thus, rotation about the rotation axis provided by the driving unit 50 in order to slice the frozen product. The container 20 thus facilitates that the identification element 22 can be easily read by the reading unit 41, in particular without providing any further means for bringing the container 20 and/or the reading unit 41 in a position in order to read the identification element 22. Furthermore, a user of the device 10 does not require to specifically insert the container 20 in the device 10 for reading the identification element 22 by the reading unit 41; the user merely needs to insert the container 20 in the device 10 for slicing the frozen product in order to also read the identification element 22 by the reading unit 41.

The container 20 may comprise a movable lid 90 being provided on the first end 20a of the container 20. The moveable lid 90 is adapted to cooperate with the driving unit 50 in order to displace the frozen product along the rotation axis and towards or through the second end 20b of the container 20 and, thus, towards the slicing element 60. The lid 90 may be designed in the form of a piston for displacing the frozen product towards the slicing element 60. As exemplarily shown in FIG. 1 and indicated with the straight arrow, the driving unit 50 may be configured to displace the lid 90, thereby displacing the frozen product towards the slicing element 60 in order to effectively slice the frozen product. In these exemplary examples, the slicing element 60 remains stationary. The slicing element 60 may also move in the inside of the container 20, as exemplary shown in FIGS. 3 and 5, wherein the driving unit 50 displaces the lid 90 and, thus, the frozen product towards the moving slicing element 60; alternatively, the lid 90 may also remain stationary, e.g. by providing a counter force on the lid 90 by the driving unit 50 or any other stationary element in contact with the lid 90.

As shown in FIG. 7, the cross-section of lid 90 has preferably a shape or circumference, which corresponds to the shape of the cross-section of the container inner wall and/or the sidewall 20c of the container 20. In the example shown in FIG. 7, the lid 90 has thus a shape in the form of an octagon. Having the corresponding shapes, the lid 90 can be guided for displacing the frozen product towards the slicing element 60. Since the lid 90 is, thus, only moveable along the displacing axis, which is preferably the rotation axis, the lid 90 may also be used for transferring a rotational movement about the rotation axis from the driving unit 50 to the container 20 and, thus, to the frozen product.

The lid 90 may comprise a circumferential edge, which comprises a sealing element for closing the container 20, in particular an opening on the side of the first end 20a of the container 20, by the lid 90 in a sealing manner. That is, the sealing element may be provided such that when the lid 90 closes the container 20 from the first end 20a of the container 20, the sealing element is pushed against the container inner wall 301 of the container 20, thereby sealing a gap between the circumferential edge of the lid 90 and the container inner wall 301. The sealing element preferably runs along the entire circumferential edge of the lid 90. The pushing force of the sealing element acting against the container inner wall 301 is thus such that a sufficient sealing is effected, while the pushing force still facilitates the displacement of the lid 90 along the container inner wall 301, i.e. towards the slicing element 60. Preferably, the sealing element is a sealing lip. In other examples, the sealing element may also be differently designed, e.g. in the form of an O-ring. The sealing element is preferably integrally formed with the lid 90, i.e. lid 90 and sealing element preferably form a monolithic structure.

The container 20 may comprise a further lid (not shown), which is provided on the second end 20b of the container 20, i.e. at the bottom of the container 20 (see FIG. 7). The function of the further lid is, in particular, to close an opening on the side of the second end 20b, through which the frozen product can be displaced, before the further lid is removed for processing the frozen product of the container 20 in the device 10. As such, degradation of the frozen product by way of the second end 20b, i.e. by way of the opening of the second end 20b, can be effectively prevented or at least reduced. The further lid is designed for being manually removed from the container 20 prior to the processing by the device 10. The further lid may be glued to the container 20 in order to facilitate easy removal of the further lid from the container 20. The further lid may also be designed to open, when the frozen product is displaced towards or through the second end 20b. That is, the pushing force of the frozen product acting on the further lid due to the displacement of the frozen product towards the slicing element 60 may remove or tear the further lid such that the frozen product can be displaced through the opening 95. Preferably, the further lid comprises weakened regions (e.g. a thinner wall thickness and/or perforations), which facilitate the tearing/removing of the further lid.

A method for using the previously described device 1o/system 100 and container 20 comprises the following steps: rotating the container 20 and the frozen product, preferably being displaced towards or through the second end 20b of the container, by the driving unit 50 about a rotation axis relative to the slicing element 60 in order to slice the frozen product, and reading a machine-readable identification element 22 provided on the sidewall of the container by the reading unit 41, when the sidewall 20c and thus the identification element 22 rotate about the rotation axis.

The method may further comprise the step of displacing or dispensing the frozen product from the container 20 and slicing it, preferably at a certain rate defined by the relative motion of the slicing element 60 and of the frozen product. The method may further comprise the step of dissolving and homogenizing the sliced product with a jet of liquid provided by the injection unit 70.

The method of the invention may further comprise the step of detaching at least partially the frozen product inside the container 20 before it is sliced, preferably by heating, the heating being typically provided by the heating unit 21, as shown in FIG. 1. Preferably, the detachment of the frozen product from the container is made by heating this product without producing liquid out of it, or a very limited amount of liquid. The heating unit 21 can be resistive, induction, infrared, hot air, etc. The preferred execution will be using a hot air heating unit 21 because of its simplicity.

The method of the invention may further comprise the step of retrieving information in the identification element 22 of the container 20 by the reading unit 41 and controlling, by the control unit 40, the device 10, in particular the driving unit 50, the injection unit 70, the heating unit 21, and/or the stirring element 31 according to corresponding processing parameters, depending on the type of frozen product in the said container 20. The jet of liquid provided by the injection unit 70 to the sliced product can also be previously heated by a heater 71, as schematically shown in FIG. 1. It is also an option of the system of the invention to provide a later heating of both the sliced product and the jet of liquid, typically by means of a mixing heating unit 32 arranged in the recipient 200, as represented in FIG. 1.

In summary, as previously explained, the present invention addresses a system for delivering chilled or frozen beverages in a very short time and in a very compact manner, since by the position of the reading unit 41 as described above, further elements facilitating the reading or detection or recognition of the identification element 22, in particular driving elements of the driving unit 50, can be omitted. This provides also a very convenient use for the user of the device 10, since the user does not need to specifically position the container 20 in the device (thus, no indexing is required). The frozen products used in the device 10 are frozen blocks stored in the user's freezer, in a container 20 suitable to insert in the device 10 of the system of the invention. Thus, the user only inserts a container 20 with the frozen block of product in the device 10 and it is processed. The processing comprises a first step, which consists in a slicing of the frozen product block so as to get ice flakes (shaved ice) of the product, as explained; then, these flakes may be sprayed by a water jet so as to dissolve whole or part of it (further providing homogenization), depending on the desired final texture and temperature of the beverage. The device parameters are mainly the speed and thickness of the slicing, the positioning of the product block (the product can be layered for complex preparations, as represented schematically in FIGS. 6a and b, for example), the temperature and quantity of water.

From a product point of view, the advantages of the system of the invention are numerous. First, the freezing process allows working with natural and fresh ingredients (nutriments are not damaged) and offer a very long preservation. Then, the slicing method allows cutting small pieces of product enlarging the scope of textures and in-mouth feelings. The variety of ingredients used in the device is very large, including fruits, vegetables, syrups, herbs, cereals, etc. The system of the invention is able to provide real cold and natural and fresh products using a low cost device. Therefore, the system of the invention offers a wide range of real frozen and cold beverages in a very convenient way and with a compact and low-cost device. Moreover, the advantage of frozen base product are numerous and in line with present beverage trends demanding more freshness and natural products.

An embodiment of the system of the invention uses an additional mixing chamber to complete the shaving and dissolving features. The range of preparations is enlarged thanks to the mixing chamber arranged after the product outlet. Some of the advantages of this additional mixing chamber are the following:
increased number of preparations through mixing/foaming;
increased homogeneity of the beverages;
decrease of dilution ratio (no or less water addition for homogenization);
new textures, notably through foaming;
hygienic system allowing the use of liquid products other than water;
mixing technology can be either built-in the device or presented as an accessory for the device;
can be connected and driven by the master device for complex recipes.

It should be clear to a skilled person that the embodiments shown in the figures are only preferred embodiments, but that, however, also other designs of the device 10, the system 100 and of the container 20 can be used.

1. Device for receiving a container comprising a frozen product and for processing the frozen product of the container for delivering a frozen or chilled beverage, wherein the container comprises a first end, a second end and a sidewall extending between the first end and the second end, the device comprising:
a slicing element,
a driving unit configured to rotate the container and thus the frozen product about a rotation axis for rotating the frozen product relative to the slicing element in order to slice the frozen product, and
a reading unit configured to read a machine-readable identification element of the container, wherein the reading unit is positioned such that an identification element provided on the sidewall of the container is readable by the reading unit, when the container is rotating about the rotation axis.

2. Device according to claim 1, wherein the reading unit is configured to read the identification element in an identification element reading direction, and wherein, when viewed in a side view of the device, the identification element reading direction is substantially perpendicular to the sidewall and/or the rotation axis.

3. Device according to claim 1, wherein the reading unit is provided laterally with respect to the slicing element and the rotation axis.

4. Device according to claim 1, wherein the driving unit is configured to displace the frozen product along the rotation axis and towards the second end of the container and thus towards the slicing element.

5. Device according to claim 1, wherein the device further comprises a holder for receiving the container, and wherein the driving unit is configured to rotate the holder about the rotation axis for rotating the container about the rotation axis.

6. Device according to claim 5, wherein the holder comprises a receiving wall for receiving the container, the receiving wall comprises an opening, through which the identification element provided on the sidewall of the container is readable by the reading unit.

7. Device according to claim 5, wherein holder comprises a handle, wherein the handle is connected to the holder such that the holder can rotate relative to the handle about the rotation axis.

8. Device according to claim 1, wherein the reading unit is an optical reader.

9. Device according to claim 1, wherein the device further comprises an injection unit for providing a jet of liquid to the sliced product.

10. Device according to claim 1, wherein the device comprises a heating unit adapted to be coupled with the container to at least partially detach the frozen product inside the container before it is sliced.

11. Device according to claim 1, wherein the device comprises a mixing chamber for receiving the sliced product, wherein, preferably, the injection unit is provided for injecting the jet of liquid into the mixing chamber.

12. Device according to claim 1, wherein the mixing chamber comprises a stirring element for stirring the sliced product in the mixing chamber.

13. Device according to claim 1, wherein the device comprises a control unit being configured to control the driving unit, the injection unit, the heating unit and/or the stirring element based on parameters read by the reading unit.

14. A container for a device comprising a frozen product and for processing the frozen product of the container for delivering a frozen or chilled beverage, wherein the container comprises a first end, a second end and a sidewall extending between the first end and the second end, the device comprising a slicing element, a driving unit configured to rotate the container and thus the frozen product about a rotation axis for rotating the frozen product relative to the slicing element in order to slice the frozen product, and a reading unit configured to read a machine-readable identification element of the container, wherein the reading unit is positioned such that an identification element provided on the sidewall of the container is readable by the reading unit, when the container is rotating about the rotation axis, wherein the container comprises a first end, a second end and a sidewall extending between the first end and the second end, and wherein the container is rotatable about a rotation axis for rotating a frozen product of the container relative to the slicing element in order to slice the frozen product, and wherein the sidewall comprises a machine-readable identification element such that the identification element is readable by the reading unit, when the container is rotating about the rotation axis.

15. Container according to claim 14, wherein the first end of the container comprises a moveable lid for cooperating with the driving unit in order to displace the frozen product along the rotation axis and towards the second end of the container and thus towards the slicing element.

16. Container according to claim 14, wherein the second end of the container comprises a further lid being designed for being removed from the container prior to the processing by the device.

17. Container according to claim 14, wherein the identification element is a barcode.

18. Container according to claim 14, wherein the identification element includes information of the frozen product contained in the container and/or parameters for processing the frozen product of the container.

19. (canceled)

20. Method for reading a machine-readable identification element of a container comprising a frozen product and received in a device for processing the frozen product of the container for delivering a frozen or chilled beverage, wherein the container comprises a first end, a second end and a sidewall extending between the first end and the second end, the method comprising the steps of:
rotating the container by a driving unit about a rotation axis relative to a slicing element in order to slice the frozen product, and
reading a machine-readable identification element provided on the sidewall of the container by a reading unit, when the sidewall and thus the identification element rotate about the rotation axis.
